(19) United States
(12) Patent Application Publication
(10) Pub. No.: US 2021/0140122 A1
(43) Pub. Date: May 13, 2021

(54) METHOD AND SYSTEM FOR MONITORING A TRACK LINE

(71) Applicants: PLASSER & THEURER EXPORT VON BAHNBAUMASCHINEN GMBH, WIEN (AT); FRAUSCHER SENSORTECHNIK GMBH, ST. MARIENKIRCHEN (AT)

(72) Inventors: KRZYSZTOF WILCZEK, WIEN (AT); FLORIAN AUER, WIEN (AT); FRITZ KOPF, WIEN (AT); MARTIN ROSENBERGER, EGGERDING (AT); STEFAN HUBER, PERLESREUT (DE); GAVIN LANCASTER, MUENZKIRCHEN (AT); RENE ZEILINGER, SANKT FLORIAN AM INN (AT)

(21) Appl. No.: 17/259,356

(22) PCT Filed: Jun. 24, 2019
(86) PCT No.: PCT/EP2019/066588

§ 371 Date: Jan. 11, 2021

(30) Foreign Application Priority Data
Jul. 11, 2018 (AT) A 204/2018

(51) Int. Cl. E01B 35/12; E01B 27/16; B61L 25/02; G01H 9/00; G01S 19/01; G01P 15/00

(52) U.S. Cl. CPC E01B 35/12; E01B 27/16; B61L 25/025; G01H 9/004; B61L 23/044; G01P 15/00; E01B 2203/127; B61L 2205/00; G01S 19/01

(57) ABSTRACT

A method for monitoring a track line by way of a monitoring device which is connected to a sensor extending along the track line. The sensor which is set in vibration delivers measurement data for the monitoring device. A rail vehicle travels on the track line, during which vibrations having known vibration values are introduced into the track line and transmitted to the sensor. Position data of the rail vehicle are recorded and an evaluation device derives a characteristic of the vibration transmission from the vibration values, the position data, and the measurement data for the track line. In this manner, a calibration of the system takes place with only a single run on the track line.

### FIELD OF TECHNOLOGY

The invention relates to a method for monitoring a track line by means of a monitoring device which is connected to a sensor extending along the track line, wherein the sensor which is set in vibration delivers measurement data for the monitoring device. The invention further relates to a system for implementing the method.

### PRIOR ART

Various monitoring devices are installed along track lines in order to monitor the railway traffic, the rail infrastructure and other activities on the track. These include, for example, axle counting systems which are in use as train detection systems. Further known monitoring devices are video systems, temperature sensors, etc. In addition, cables or lines installed alongside a track can be used as components of a monitoring system.

According to EP 3 275 763 A1, for example, a monitoring device is known which is connected to a fibre optic cable installed next to the track. This monitoring device records vibrations or structure-borne sound along the track line. Specifically, reflections of laser impulses are detected in a glass fibre of the fibre optic cable. These reflections change when sound waves hit the fibre optic cable. For example, a coherent laser impulse at a pre-defined frequency is sent into a monomode fibre. Natural inclusions within the fibre reflect parts of this laser impulse back to the source (backscattering). On the basis of a backscattering component, specially-developed algorithms enable conclusions as to the location and character of a vibration source along the track line.

In this, the difficulty exists that the transmission of vibrations from a vibration source to the fibre optic cable depends on a multitude of unknown influences. Usually, the fibre optic cable is installed in a cable duct which does not always extend parallel to the track. Additionally, cable loops are provided in order to be able to perform a length compensation, if needed. Thus, on a monitored track section, the length of the fibre optic cable as a rule differs from the length of the track line. Also, a location-dependent composition of the ground and the track bed significantly influences the vibration transmission.

In order to surmount these difficulties, for example, output signals of a position sensor arranged at the track (axle counter, for instance) are evaluated together with the detected light reflections in the glass fibre. By combining these two measuring results, the position of a track vehicle can be determined with sufficient precision over the entire track line, wherein the approximate position between the position sensors is derived from the detected light reflections of the glass fibre. The position sensors deliver a reliable allocation of the track currently travelled upon also in the case of tracks extending in parallel.

### SUMMARY OF THE INVENTION

It is the object of the invention to indicate an improvement over the prior art for a method and a system of the type mentioned at the beginning.

According to the invention, these objects are achieved by way of the features of claims 1 and 8. Dependent claims indicate advantageous embodiments of the invention.

In this, a rail vehicle travels on the track line, during which vibrations having known vibration values are introduced into the track line and transmitted to the sensor. In addition, position data of the rail vehicle are recorded, wherein, by means of an evaluation device, a characteristic of the vibration transmission is derived from the vibration values, the position data and the and the measurement data for the track line. In this, known vibration values are, in general, set parameters or recorded measurement values which characterize the introduced vibrations. In this way, a calibration of the system takes place with only a single run on the track line. In particular, by means of the known vibration emissions and the position data, it is determined for each location on the track line how the locally present conditions affect the sensor measuring data. In this, damping or sound-reflecting elements between the vibration source and the sensor are especially relevant. For subsequent measurements, these results are included in the evaluation of the sensor measuring data. There is no necessity for further sensors arranged along the track in order to perform a precise localization of sound- or vibration sources on the monitored track section.

A further development of the method provides that the characteristic of the vibration transmission is stored as a transmission function in the monitoring device. With this, a precise and quick evaluation of the sensor measuring data can be carried out, wherein the transmission function can be optimized for various cases of application. For example, certain vibration frequencies can be filtered out if these are not relevant for the specific evaluation.

Advantageously, the measurement data are derived from signal data of a fibre optic cable, in particular by means of distributed acoustic sensing via at least one optical fibre. By means of the so-called distributed acoustic sensing (Distributed Acoustic Sensing, DAS) the fibre optic cable can be used as a virtual microphone. To that end, only minimal operations at the ends of an optical fibre are required, wherein it is also possible to use fibre optic cables already laid in track installations. As a rule, in such fibre optic cables there are always individual fibres freely available for the present application.

For off-line processing of the data it is advantageous if a timer of the rail vehicle and a timer of the monitoring device are synchronized, and if the recorded data are stored in a time-related manner. Thus, the data of the rail vehicle and the data of the monitoring device are linked via the time, so that the evaluation can be carried out by means of the evaluation device after travel on the track.

Favourably, the position of the rail vehicle is recorded by means of a GNSS receiver. Such a device for satellite-supported position determination is often already present and can be used for the present method.

It is additionally advantageous if the vibrations are introduced by means of a work unit of a track maintenance machine. In this way, defined vibrations are emitted, wherein the location of introduction and corresponding vibration parameters are accurately known. In this, a calibration of the monitoring device takes place in the course of a track treatment by means of the track maintenance machine.

In this, an improvement provides that control data and/or work parameters of the track maintenance machine are transmitted to the evaluation device, and that these are coordinated with the measurement data. For example, the condition of a track bed along the track line can be evaluated by repeated comparison of the measurement data to the control data or work parameters. In addition, the execution of working operations of the track maintenance machine can be monitored with this.

The system, according to the invention, for implementing one of the above-described methods comprises the monitoring device for which measurement data are supplied by the sensor extending along the track line. The system further comprises a rail vehicle which is configured for the recording of vibrations generated by means of the rail vehicle as well as of position data, and an evaluation device which is configured for coordinating the measurement data with recorded data of the rail vehicle, in order to derive a characteristic of the vibration transmission for the track line. By way of the system, the measurements of the monitoring device are compared to the vibrations introduced during travel on the track line and to the positions of the rail vehicle.

A simple embodiment of the system provides that the rail vehicle comprises an acceleration sensor for recording the generated vibrations. For example, an acceleration sensor attached to a wheel axle delivers data (acceleration, frequency, amplitude, etc.) of the vibrations introduced into the track by means of a wheel.

For position determination it is advantageous if the rail vehicle comprises a GNSS receiver for recording a position of the rail vehicle.

In order to compare the recorded data off-line, it is useful if the rail vehicle comprises a timer, if the monitoring device comprises a timer, and if both timers are configured for synchronous operation.

Advantageously, the rail vehicle is a track maintenance machine which is configured for generating specific vibration emissions. Then, the treatment of the track line by means of the track maintenance machine can be used for determining the characteristic of the vibration transmission to the sensor.

For the emission of particular vibrations, it is useful if the track maintenance machine comprises a work unit which has a vibration generator and is designed, in particular, as a tamping unit or a stabilizing unit. In this, the recording of the emitted vibrations can take place via an evaluation of control data or work parameters.

Often, fibre optic cables for data transmission are installed along track lines. Therefore, an advantageous embodiment of the system provides that the sensor comprises a fibre optic cable. Thus, the infrastructure already present can be used.

According to a further improvement, the rail vehicle comprises measuring devices for detecting track objects. This is important especially when the position or condition of the track objects has an influence on the vibration transmission from a vibration source to the sensor. Optionally, the recorded object data are included in the determination of the transmission characteristic.

### BRIEF DESCRIPTION OF THE DRAWINGS

The invention will be explained below by way of example with reference to the accompanying drawings. There is shown in schematic representation in:

FIG. 1 a cross-section of a track line and a rail vehicle

FIG. 2 a cross-section of a track line and a track maintenance machine

FIG. 3 vibration emissions of a track maintenance machine

FIG. 4 vibration emissions of a train

FIG. 5 determining the transmission function

FIG. 6 path-time diagrams and transmission function

### DESCRIPTION OF THE EMBODIMENTS

FIG. 1 shows a cross-section of a track line 1 on which a rail vehicle 2 is travelling. The track line 1 has the typical shape of a railway embankment with a track ballast bed 3. Supported in the track ballast bed 3 is a track grid which consists of sleepers 4 and rails 5 fastened on the sleepers. This arrangement forms the superstructure of the track line 1. Often provided as a substructure under the track bed 3 is an intermediate layer 6 and a drainage layer 7. A sensor 8 extends along the track line 1 next to the bedding. This is, for example, a fibre optic cable, guided in a cable duct 9, which is used as an acoustical sensor in the context of the present invention. Usually, further track objects 10 such as balises, signal devices etc. are arranged along the line 1.

During travel on the track line 1, the rail vehicle 2 transmits via its wheels 11 unequal forces Q to the rails 5, wherein these forces Q are dissipated via the superstructure to the substructure and at last to the underground. In this way, the rail vehicle 2 emits vibrations 12 which spread dynamically, in the shape of waves, as deformations of the transmission elements 3-7. By way of this vibration transmission 13, the sensor 8 located in the cable duct 9 is also set in vibrations.

The introduced vibrations 12 are recorded, for example, in an evaluation device 15 of the rail vehicle 2 by means of an acceleration sensor 14 arranged on an axle. In the evaluation device 15, vibration values a, Q are linked with position data x which are determined, for example, by means of a GNSS receiver 16. Favourably, the evaluation device 15 comprises a timer 17 to provide the recorded data with a time stamp.

Shown in FIG. 2 is a comparable operation with a rail vehicle 2 configured as a track maintenance machine. Specifically, this is a track tamping machine having, as a work unit 18, a tamping unit which can be lowered into the track ballast bed 3. By means of this work unit 18, pre-defined vibrations 12 are emitted. In this, a vibration transmission 13 via the track grid is omitted. Vibration values are derived either from control data and work parameters of the track maintenance machine, or detected by means of an acceleration sensor 14. In particular, the work parameters of a vibration generator 19 acting in the work unit 18 deliver usable vibration values. For example, the speed of rotation of an eccentric drive employed for vibration generation indicates the frequency of the vibration 12 introduced into the track.

The track maintenance machine is shown in FIG. 3 in a side view. Here, as an additional work unit 18, a stabilizing unit is arranged behind the tamping unit with regard to the working direction 20. By means of the stabilizing unit, defined horizontal vibrations 12 are introduced into the bedding via the rails 5 and the sleepers 4. The sensor 8 is connected to a monitoring device 21 at a readily accessible location of the track line 1. If the sensor 8 is a fibre optic cable for data transmission, an unused light-transmitting fibre is sufficient to establish a connection to the monitoring device 21.

The vibrations 12 transmitted by the track maintenance machine to the sensor 8 are registered by means of the monitoring device 21. In this, it must be noted that a fibre optic cable is usually loosely laid next to other conductors in the cable duct 9. Vibrations 12 introduced into the bedding are thus transmitted unevenly to the fibre optic cable. In particular, the dynamic characteristics of the transmission elements 3-7 and the cable duct 9 determine a transmission function T between the introduced vibrations 12 and the registered oscillations of the fibre optic cable.

The position of the track maintenance machine is known because the track work takes place location-dependent. For example, a kilometre mileage of the track is used to define a work location. For recording the current position, an odometer or a GNSS receiver 16 is employed, for example. Also, a location determination by means of recorded track objects 10 is useful. To that end, for example, laser scanners are arranged on the track maintenance machine for contactless scanning of the track and its surroundings.

In FIG. 4, a rail vehicle 2 configured as a train is travelling on a track line 1. For example, a locomotive pulls an unloaded and a loaded wagon. At least one axle of the locomotive has an acceleration sensor 14 for recording vibrations 12 emitted into the track. Local installations 22 may lead to shielding or reflections of the introduced vibrations 12. The entire transmission function T is here determined by a complex three-dimensional superimposition of the rail stimulation at many points (wheel contact points) and the associated individual transmission relations up to the location of the vibration measurement (fibre optic cable).

In this, each train has a specific emission pattern which results from the travel speed and the composition of the train. In the example according to FIG. 4, the emission pattern is characterized by the stiffly spring-supported locomotive, the slight load by the unloaded wagon, the increased load by the loaded wagon and, optionally, by flat spots on wheel rims, etc. At the wheel contact points, the rails 5 are loaded with the emission pattern, wherein the latter moves along the track line 1 with the train.

Imperfections of the track, such as, for example, corrugation formation on the rail head, rail breakage 23, waviness 24 of the track, cavities, defective sleepers 4, or rail fastenings etc., are stationary sources of vibrations. As a result, vibrations are stimulated when a train travels over these. Also, variations in the superstructure design (ballasted track, ballast-less track 25) and structures 26 (bridges, tunnels, etc.) along the track line 1 play a part here.

Each individual vibration of a wheel contact point is transmitted in the fibre optic cable to an observed measuring point. The resulting transmission function T depends on all of the elements 3-7, 9, 22-26 which determine the vibration transmission 13. For this reason, the fibre optic cable does not measure at the measuring point a physical unit representing a specific oscillation. Instead, the fibre optic cable emits to the monitoring device 21 a signal describing all the superimposed vibrations 12 which act on the fibre optic cable at the observed measuring point. The transmission function T represents this complex relationship and serves for calibrating the system.

By way of FIG. 5, the determination of the transmission function by means of a track maintenance machine is described. A path x measured along the rails 5 defines the position of the track maintenance machine on the track. As point of departure, for example, that point is defined where the monitoring device 21 is connected to the sensor 8. From there, the sensor 8 extends in a divergent path y up to an observed measuring point. For example, a cable duct 9 does not always extend parallel to the track, or cable loops are provided for length compensation.

The track maintenance machine comprises two working units 18, each of which exerts a force Q_{A}(t, x), Q_{S}(t, x) variable over the time t on the track and in this manner generate vibrations 12. During this, a stabilizing unit applies a force Q_{A}(t, x) on the rails 5, and a tamping unit applies a force Q_{S}(t, x) directly on the ballast bed 3.

The transmission function T consists of three components, i.e. a transfer function rail grid S(x), a transfer function bedding B(x) and a transfer function sensor F(y):

$$T ( x , y ) = ( \begin{matrix}S ( x ) \\ B ( x ) \\ F ( y )\end{matrix} ) or T ( t ) = ( \begin{matrix}S ( t ) \\ B ( t ) \\ F ( t )\end{matrix} )$$

In this, the path x serves as a variable by which the transmission system is discretized along the rail 5. Along the sensor 8, a discretizing takes place by means of the variable y. In a corresponding manner, the transfer functions can be recorded in a time-dependent manner, wherein it is known at which time t a working unit 18 emits a vibration 12 at which location. The location reference thus takes place via time specifications. In this, the monitoring device 21 comprises a timer 17 which is synchronized with a timer 17 of the track maintenance machine.

The transfer function rail grid S(x) describes the characteristics of the vibration transmission of the rails 5 and sleepers 4 dependent on the path x:

s(x)=(s₁(x) s₂(x) . . . )

The parameterizing takes place by means of values s_{S} at the respective observed measuring point, wherein in particular effects of the rail surface, switch components or rail breakages are identified and parameterized.

The transfer function bedding B(x) describes the characteristics of the vibration transmission starting from the sleeper lower edge up to the sensor 8:

$$B ( x ) = ( \begin{matrix}{b}_{1 , 1} ( x ) & {b}_{1 , 2} ( x ) & … \\ ⋮ & ⋮ & … \\ {b}_{k , 1} ( x ) & {b}_{k , 2} ( x ) & ⋱\end{matrix} )$$

By the line number k of the matrix, the bedding is discretized starting from the sleeper lower edge up to the sensor 8. In the lines, those parameters are identified and parameterized which influence the vibration transmission (spreading speed, damping, reflection, . . . ).

The transfer function sensor F(y) describes, for example, the characteristics of an optical fibre:

F(y)=(f₁(y) f₂(y) . . . )

The parameterizing takes place by means of values f_{f} at the respective observed measuring point, wherein the individual parameter values indicate, for example, an inherent fibre signal damping, spatial relations (y→x), contact characteristics of the fibre optic cable with the transfer function bedding B(x) and, cable characteristics (reinforcement etc.).

The respective work unit 18 is described by a vector A:

$$A = ( \begin{matrix}Q \\ {a}_{1} \\ ⋮ \\ {a}_{m}\end{matrix} )$$

The values aₐ describe parameters of the emitted vibration 12. The same goes for an axle of the train, wherein here the static wheel load is indicated as force Q. The parameter values aₐ indicate, for example, a polygonising, flat spots, the wheel profile, etc. The effect of an entire train on the track at the time t is described by a matrix Z(t):

$$Z ( t ) = ( \begin{matrix}{A}_{1} & ⋯ & {A}_{n} \\ {x}_{1} & ⋯ & {x}_{n} ( t )\end{matrix} )$$

For determining the transmission function T, the stimulation of the track by the respective work unit 18 or by an axle with vibration recording is used. In this, the effective force Q over the time t or over the corresponding location along the rails 5 is indicated in each case:

Q(t) or Q(x)

A measurement by means of the monitoring device 21 for an observed measuring point along the sensor 8 yields a matrix M(t, y):

$$M ( t , y ) = ( \begin{matrix}{m}_{1} \\ ⋮\end{matrix} )$$

In this, the respective values mₘ are measured along the positions or the path y and are assigned to the corresponding parameters of the introduced vibrations 12. Corresponding parameters are, for example, amplitudes, frequencies, stretching, etc.

The actual determination of the transmission function T takes place in an evaluation device 27 which is set up, for example, in the monitoring device 21, a system central or a computer connectable to the monitoring device 21. By means of said evaluation device 27, recorded data of the emitted vibrations 12 are synchronized with the measuring values of the sensor 8. For example, when a train travels over the track line 1 at the time t, the corresponding train matrix Z(t) is used. The overlapping emitted vibrations 12 (emission pattern) are transmitted to the rails 5 by way of the transmission function T and measured as matrix M(t, y):

$$Z ( t ) {\to }^{ T } M ( t , y )$$

Without a defined stimulation of the system, the transmission function T could be defined only imprecisely by means of pattern comparison. In this, the stimulations by a train in the shape of a train matrix (t) could be reconciled only empirically with the matrix M(t) obtained during a measurement.

However, with a defined stimulation (track maintenance machine or train with measured axle accelerations), the characteristics of the transmission function T can be determined with sufficient precision:

$$Q ( t , x ) {\to }^{ T } M ( t , y )$$

By way of the corresponding parameterizing of the transmission function T, a calibration of the monitoring device 21 takes place.

In the case pf repeated measurements with defined and undefined stimulations, the precision of the transmission function T can be improved by means of statistical methods. Specifically, confidences to the parameters of the transmission function T can be compiled via statistical evaluations. If deviations are observed during a later measurement, corresponding conclusions as to changes in the system (flat spots on wheel rims, polygon formation, rail fractures, etc.) can be drawn.

Lacking such system changes, the transmission function T can be regarded as unchangeable over short time periods (the duration of a train journey, or a few days). The emission pattern of a respective train is also assumed to be unchangeable at least during a run. With application of statistical methods by analysis of the numerous travels in railway operation, these assumptions lead to unambiguous solutions which far surpass the precision of the individual measurements. In this manner, the stationary characteristic of the track line 1 becomes known with ever more precision. The emission pattern of a train can also be traced over the entire observed track line 1 and can be determined relatively precisely by statistical methods. When assessing the train characteristics, outliers can be detected immediately.

The characteristics change only over longer time periods, so that a renewed calibration of the system is useful. Triggers of such changes can be seasonal fluctuations of the ground characteristics, construction work, great weather events, as well as wear manifestations of the track (corrugation formation on rails 5, pumping switch frog, ballast wear, etc.). Monitoring of these long-term changes takes place by means of time series and repeated calibrations. In this manner, slow changes can be tracked. Conversely, abrupt changes of the track characteristics (for example, rail fracture) are noticed immediately.

With the transmission function T, unambiguous monitoring outcomes result from the measured signals of the sensor 8. Characteristic emission patterns of a travelling train are just as recognizable as condition changes of the track line 1 or stationary sources of vibration.

FIG. 6 shows in a time-path diagram on the left-hand side those measuring signals which are initially recorded by means of the sensor 8 in the monitoring device 21. The corresponding track section 1 is a double-track railway line. The time t is shown on the abscissa, and the ordinate reflects the position of the measuring points along the sensor 9.

Local transmission relationships are compensated by the described mathematical transformation by means of the transmission function T. Thus, on the right-hand side, a time-path diagram with calibrated measuring signals ensues by means of which unadulterated emission patterns of trains can be recorded along the track line 1. By statistical evaluations, the characteristics of stationary vibration sources can also be detected.

For example, a first pattern progression 28 shows the movement of an emission pattern of a fast train which passes a slow train (second pattern progression 29) at a first stop (horizontal progression). A horizontal bar 30 in both pattern progressions 28, 29 shows a local imperfection (for example, rail fracture) of the respective track. On the adjacent track, a head-on approaching train is moving which does not halt at any stop (third pattern progression 31).

Thus, the advantage of a calibration by means of the transmission function T is that the recognized local transmission relations are compensated in order to make emission patterns of trains and characteristics of stationary vibration sources interpretable and trackable.

1-15. (canceled)

16. A method of monitoring a track line, the method comprising:
providing a monitoring device which is connected to a sensor extending along the track line, wherein the sensor, upon being set in vibration, delivers measurement data for the monitoring device;
traveling on the track line with a rail vehicle and introducing vibrations having known vibration values into the track line and transmitting to the sensor;
recording position data of the rail vehicle;
with an evaluation device, deriving a characteristic of the vibration transmission from the known vibration values, the measurement data delivered by the sensor, and the position data for the track line; and
storing the characteristic of the vibration transmission as a transmission function in the monitoring device.

17. The method according to claim 16, which comprises deriving the measurement data from signals of a fiber optic cable.

18. The method according to claim 17, which comprises deriving the measurement data by distributed acoustic sensing via at least one optical fiber of the fiber optic cable.

19. The method according to claim 16, which comprises synchronizing a timer of the rail vehicle and a timer of the monitoring device, and storing the recorded data in a time-related manner.

20. The method according to claim 16, which comprises recording the position of the rail vehicle by way of a GNSS receiver.

21. The method according to claim 16, wherein the step of introducing the vibrations comprises introducing the vibrations with a work unit of a track maintenance machine.

22. The method according to claim 21, which comprises transmitting control data and/or work parameters of the track maintenance machine to the evaluation device, and coordinating the control data and/or work parameters with the measurement data.

23. A system for implementing the method according to claim 16, the system comprising:
a monitoring device connected to receive measurement data from a sensor extending along a track line;
a rail vehicle configured for recording vibrations generated by said rail vehicle and position data;
an evaluation device configured for coordinating the measurement data with recorded data of said rail vehicle in order to derive for the track line a characteristic of the vibration transmission stored as a transmission function in said monitoring device.

24. The system according to claim 23, wherein said rail vehicle comprises an acceleration sensor for recording the vibrations.

25. The system according to claim 24, wherein said rail vehicle comprises a GNSS receiver for recording a position of said rail vehicle.

26. The system according to claim 24, wherein said rail vehicle comprises a first timer and said monitoring device comprises a second timer, and wherein said first and second timers are configured for synchronous operation.

27. The system according to claim 23, wherein said rail vehicle is a track maintenance machine configured for generating specific vibration emissions.

28. The system according to claim 27, wherein said track maintenance machine comprises a work unit which has a vibration generator.

29. The system according to claim 28, wherein said work unit is a tamping unit or a stabilizing unit.

30. The system according to claim 23, wherein said sensor comprises a fiber optic cable.

31. The system according to claim 23, wherein said rail vehicle comprises measuring devices for detecting track objects.
